(19) United States
(12) Patent Application Publication
(10) Pub. No.: US 2026/0259930 A1
(43) Pub. Date: Sep. 3, 2026

(54) SYSTEMS AND METHODS FOR EFFICIENT ANNS (APPROXIMATE NEAREST NEIGHBORS SEARCH) IN NVM

(71) Applicant: Kioxia Corporation, Tokyo (JP)

(72) Inventors: Assaf Sella, Tel Aviv (IL); Shimon Tsalmon, Tel Aviv (IL); Eviatar Yadai, Tel Aviv (IL); Yedidia Kaplan, Tel Aviv (IL); Yaron Klein, Tel Aviv (IL); Miki Schnarch, Tel Aviv (IL)

(21) Appl. No.: 19/068,706

(22) Filed: Mar. 3, 2025

(51) Int. Cl. G06F 16/901; G06F 12/02

(52) U.S. Cl. CPC G06F 16/9024; G06F 12/0246

(57) ABSTRACT

The present disclosure relates to a flash memory system including one or more processors and a non-volatile memory configured to store information pieces related to a plurality of nodes of a graph. The one or more processors may determine a first order of the plurality of nodes that is an ascending order of a number of hops of each of the plurality of nodes from a particular node. For one or more nodes with a same number of hops, the one or more processors may determine a second order of the one or more nodes that is a descending order of a number of neighbors of each of the one or more nodes in the graph. The one or more processors may write, to the non-volatile memory, information pieces related to the plurality of nodes to be arranged in at least the first order and the second order.

### TECHNICAL FIELD

The present arrangements relate generally to systems and methods for performing operations of a flash memory, and more particularly to systems and methods for writing, to a non-volatile memory (NVM), data representing or corresponding to a plurality of nodes of a graph and/or performing an ANNS (approximate nearest neighbors search) on the graph stored in the NVM.

### BACKGROUND

Approximate Nearest Neighbor Search (ANNS) algorithms aim to efficiently find the closest vectors to a given query vector within a large vector space. Graph-based ANNS methods can connect vectors in the space via a graph structure, where the search algorithm traverses the graph to locate the nodes (vectors) closest to the query. These algorithms can be used to retrieve most relevant information elements from external data sources. In one approach, ANNS can be used in applications of Retrieval-Augmented Generation (RAG)-based Large Language Models (LLMs). In this approach, the LLM can utilize external information sources containing up-to-date and reliable information to ground its responses. The effectiveness of grounding can increase with the size of the external dataset.

The conventional ANNS algorithms can store vectors in DRAM or store highly duplicated vectors in an NVM to enable fast graph searches. However, these approaches do not scale well with increasing vector dataset sizes due to the high cost of the search media. Improvements in scalability of ANNs with increasing vector dataset sizes remain desired.

### SUMMARY

The present arrangements relate to system and method for writing, to an NVM, data representing or corresponding to a plurality of nodes of a graph and/or performing an ANNS on the graph stored in the NVM.

According to certain aspects, arrangements provide a method for writing, to a non-volatile memory, data representing or corresponding to a plurality of nodes of a graph. The method may include determining, by the one or more processors, a first order of the plurality of nodes that is an ascending order of a number of hops of each of the plurality of nodes from a particular node. The method may include for one or more nodes with a same number of hops, determining, by the one or more processors, a second order of the one or more nodes that is a descending order of a number of neighbors of each of the one or more nodes in the graph. The method may include writing, by the one or more processors to the non-volatile memory, information pieces related to the plurality of nodes to be arranged in at least the first order and the second order, wherein information pieces related to each node of the plurality of nodes and neighbors thereof in the graph are arranged adjacently.

According to certain aspects, arrangements provide a method for writing, to a non-volatile memory, data representing or corresponding to a plurality of nodes of a graph. The method may include determining, by one or more processors, an order of the plurality of nodes. The method may include for each node of the plurality of nodes in the order, writing, by the one or more processors, to the non-volatile memory, a set of information pieces adjacently, the set of information pieces being related to the node and one or more neighbors of the node in the graph. A first set of information pieces related to a first node and one or more neighbors of the first node may be written to the non-volatile memory adjacently to a second set of information pieces related to a second node next to the first node in the order and one or more neighbors of the second node.

According to other aspects, arrangements provide a flash memory system including one or more processors and a non-volatile memory configured to store information pieces related to a plurality of nodes of a graph. The one or more processors may determine an order of the plurality of nodes. For each node of the plurality of nodes in the order, the one or more processors may write to the non-volatile memory, a set of information pieces adjacently. The set of information pieces may be related to the node and one or more neighbors of the node in the graph. A first set of information pieces related to a first node and one or more neighbors of the first node may be written to the non-volatile memory adjacently to a second set of information pieces related to a second node next to the first node in the order and one or more neighbors of the second node.

### BRIEF DESCRIPTION OF THE DRAWINGS

These and other aspects and features of the present arrangements will become apparent to those ordinarily skilled in the art upon review of the following description of specific arrangements in conjunction with the accompanying figures, wherein:

FIG. 1 is a block diagram illustrating an example flash memory system according to some arrangements.

FIG. 2 illustrates an example of a graph including a plurality of nodes, according to some arrangements.

FIG. 3 illustrates an example of data structures in an NVM for storing data representing or corresponding to a plurality of nodes in a graph, according to some arrangements.

FIG. 4 illustrates an example of configurations for storing data representing or corresponding to a plurality of nodes in a graph before and after rearrangement of data, according to some arrangements.

FIG. 5 is a flowchart illustrating an example methodology for arranging (or rearranging) data representing or corresponding to a plurality of nodes of a graph, according to some arrangements.

FIG. 6A and FIG. 6B are diagrams illustrating an example of a graph including a plurality of nodes during arrangement (or rearrangement) of data representing or corresponding to the plurality of nodes, according to some arrangements.

FIG. 7 is a flowchart illustrating another example methodology for arranging (or rearranging) data representing or corresponding to a plurality of nodes of a graph, according to some arrangements.

FIG. 8 illustrates an example description of a greedy search algorithm, according to some arrangements.

FIG. 9 is a flowchart illustrating an example methodology for reading arranged (or rearranged) data representing or corresponding to a plurality of nodes of a graph, according to some arrangements.

FIG. 10A and FIG. 10B are diagrams illustrating example schemes of reading data stored in an NVM without rearrangement and with rearrangement, according to some arrangements.

FIG. 11 is a flowchart illustrating an example methodology for performing a beam search (or a beamwidth algorithm), according to some arrangements.

FIG. 12 is a diagram illustrating an example of sorted indexes during the execution of a beam search (or a beamwidth algorithm), according to some arrangements.

FIG. 13 is a flowchart illustrating another example methodology for performing a beam search (or a beamwidth algorithm), according to some arrangements.

FIG. 14 is a diagram illustrating an example description of a greedy search algorithm optimized for NVM, according to some arrangements.

FIG. 15A and FIG. 15B illustrate an example of entries in an index data structure before and after performing an inlining scheme, according to some arrangements.

FIG. 16 is a diagram illustrating example results (queries per second (QPS) vs. Recall@10) of throughput of a beam search, according to some arrangements.

FIG. 17 is a table showing example results of performance of a beam search, according to some arrangements.

FIG. 18 is a diagram illustrating example results (QPS vs. Recall@10) of throughput of a beam search, according to some arrangements.

FIG. 19 is a diagram illustrating example results (QPS vs. PQ cache size) of throughput of a vector selection algorithm using a product quantization (PQ) cache scheme, according to some arrangements.

FIG. 20 is a flowchart illustrating an example methodology for writing, to an NVM, data representing or corresponding to a plurality of nodes of a graph, according to some arrangements.

FIG. 21 is a flowchart illustrating another example methodology for writing, to an NVM, data representing or corresponding to a plurality of nodes of a graph, according to some arrangements.

### DETAILED DESCRIPTION

According to certain aspects, arrangements in the present disclosure relate to techniques for writing, to a non-volatile memory (NVM), data representing or corresponding to a plurality of nodes of a graph and/or performing an ANNS (approximate nearest neighbors search) on the graph stored in the NVM.

In one aspect, the conventional ANNS algorithms can store vectors in DRAM or store highly duplicated vectors in an NVM to enable fast graph searches. For example, there are various ANNS algorithms including HNSW and DiskANN. HNSW is an ANNS algorithm where both the index and vectors are stored in DRAM (dynamic random-access memory). On the other hand, DiskANN stores the graph structure (e.g., index) in SSD (solid state drive) or NVM while the vectors, which may be PQ compressed, are stored in DRAM. However, these approaches do not scale well with increasing vector dataset sizes due to the high cost of the search media. Improvements in scalability of ANNs with increasing vector dataset sizes remain desired.

To solve these problems, according to certain aspects, arrangements in the present disclosure relate to systems and methods for providing an all-in-storage ANNS with data structures optimized for NVMs and efficient access. In some arrangements, systems and/or methods aim to minimize search media costs by efficiently arranging data (e.g., vectors) and accessing NVMs (e.g., flash memory) to reduce graph search time. In some arrangements, a system (e.g., flash memory system) can enable a high-granularity trade-off between search media cost and performance, satisfying various application requirements.

In some arrangements, the system can utilize an all-in-storage architecture where both the graph structure (e.g., index) and the data (e.g., vectors) are stored in an NVM. In some arrangements, the system can arrange data (e.g., vectors) in the NVM such that neighboring vectors in the graph are placed adjacently, thereby optimizing access. In some arrangements, indexes and groups of vectors can be read in bulk with independent bulk sizes, further optimizing NVM access. In some arrangements, a graph-based ANNS algorithm can employ a greedy search algorithm that reads neighbors of the currently visited nodes. The term “greedy search” or “greedy search algorithm” refers to a problem-solving heuristic that makes the locally optimal choice at each stage with the hope of finding a global optimum, or any algorithm that selects, at each step, the best option available without considering the broader context or future consequences. In some arrangements, the graph-based ANNS algorithm can be modified to reduce the number of neighbors read from NVMs without compromising accuracy.

In some arrangements, the system can store a controllable number of vectors in a data structure (e.g., index data structure) to optimize data access, providing a high-granularity trade-off between search media cost and performance. In some arrangements, the system can store frequently used vectors in a DRAM-based cache to optimize data access and balance search media cost and performance.

In some arrangements, the system can minimize the search media cost used by an ANNS algorithm and can use efficient vector arrangement and NVM access to reduce graph search time. Consequently, the system can enable the economic scaling of the Retrieval-Augmented Generation (RAG) vector dataset, thereby improving grounding effectiveness and Large Language Model (LLM) responses. In some arrangements, the system can allow for a high-granularity trade-off between search media cost and performance, satisfying the diverse requirements of RAG or other ANNS applications.

In some arrangements, the system can arrange vectors in NVMs, pre-load bulks of indexes and vector groups with independent bulk sizes, optimize a greedy search to reduce the number of neighbors read from NVMs, and/or utilize a data structure for variable numbers of vectors placed in line with the index. In some arrangements, the system can select a subset of vectors to be stored in a limited-size static cache, minimizing NVM accesses for a given static-cache size. The term NVM refers to flash-based storage such as SSD and UFS, with SSD being used as a term to denote such flash-based storage for brevity, or any type of computer memory that retains data even when power is turned off.

Arrangements in the present disclosure have at least the following advantages and benefits. First, arrangements in the present disclosure can provide an improved ANNS algorithm with all-in-storage architecture that uses flash-optimized algorithms and data-structures to optimize search performance. Second, arrangements in the present disclosure can provide an improved ANNS algorithm that uses near zero volatile memory (e.g., DRAM) and has low SSD footprint. Third, arrangements in the present disclosure can provide a very low implementation cost that enables economic implementation of search on very large-scale vector datasets.

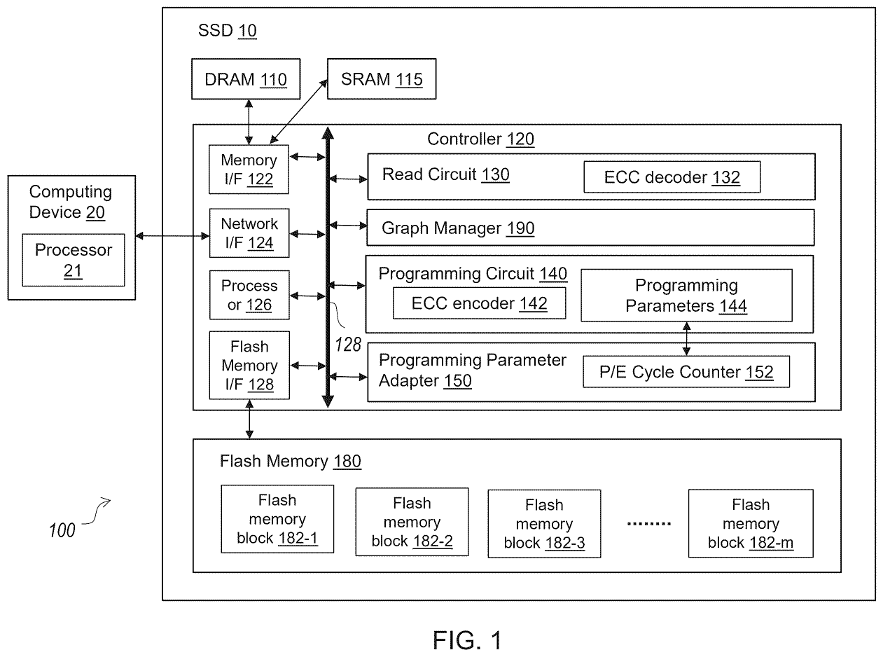

Referring to FIGS. 1-21, arrangements of systems and methods for the present solution of writing, to an NVM, data representing or corresponding to a plurality of nodes of a graph and/or performing an ANNS algorithm on the graph stored in the NVM.

FIG. 1 is a block diagram illustrating an example flash memory system according to some arrangements. Referring to FIG. 1, a flash memory system 100 may include a computing device 20 and a solid-state drive (SSD) 10, which is a storage device and may be used as a main storage of an information processing apparatus (e.g., a host computer). The SSD 10 may be incorporated in the information processing apparatus or may be connected to the information processing apparatus via a cable or a network.

The computing device 20 may be an information processing apparatus (computing device). In some arrangements, the computer device 20 which is configured to handle or process data for training and perform a training a neural network (e.g., DNN 300), and the data for training may be collected from a plurality of SSDs by a plurality of computing devices. The data collected from the plurality of SSDs may be recorded and handled/processed by a different computing device, which is not necessarily connected to any of the SSDs and which performs the training based on the collected data. The computing device 20 includes a processor 21 and/or a database system 26. The database system 26 may store read thresholds values including training sets or results of a training.

The SSD 10 includes, for example, a controller 120 and a flash memory 180 as non-volatile memory (e.g., a NAND type flash memory). The SSD 10 may include a random access memory which is a volatile memory, for example, DRAM (Dynamic Random Access Memory) 110 and/or SRAM (Static Random Access Memory) 115. The random access memory has, for example, a read buffer which is a buffer area for temporarily storing data read out from the flash memory 180, a write buffer which is a buffer area for temporarily storing data written in the flash memory 180, and a buffer used for a garbage collection. In some arrangements, the controller 120 may include DRAM or SRAM.

In some arrangements, the flash memory 180 may include a memory cell array which includes a plurality of flash memory blocks (e.g., NAND blocks) 182-1 to 182-m. Each of the blocks 182-1 to 182-m may function as an erase unit. Each of the blocks 182-1 to 182-m includes a plurality of physical pages. In some arrangements, in the flash memory 180, data reading and data writing are executed on a page basis, and data erasing is executed on a block basis.

In some arrangements, the controller 120 may be a memory controller configured to control the flash memory 180. The controller 120 includes, for example, a processor (e.g., CPU) 126, a flash memory interface 128, and a memory interface 122, a network interface 124, all of which may be interconnected via a bus 128. The memory interface 122 may include a DRAM controller configured to control an access to the DRAM 110, and a SRAM controller configured to control an access to the SRAM 115. The flash memory interface 128 may function as a flash memory control circuit (e.g., NAND control circuit) configured to control the flash memory 180 (e.g., NAND type flash memory). The network interface 124 may function as a circuit which receives various data from the computing device 20 and transmits data to the computing device 20. The data may include a plurality of sets of read thresholds or other data collected from the flash memory 180 or a plurality of SSDs for training a neural network (e.g., DNN 300).

The controller 120 may include a read circuit 130, a programming circuit (e.g. a program DSP) 140, and/or a programming parameter adapter 150. As shown in FIG. 1, the adapter 150 can adapt the programming parameters 144 used by programming circuit 140 as described above. The adapter 150 in this example may include a Program/Erase (P/E) cycle counter 152. Although shown separately for ease of illustration, some or all of the adapter 150 can be incorporated in the programming circuit 140. In some arrangements, the read circuit 130 may include an ECC decoder 132. In some arrangements, the programming circuit 140 may include an ECC encoder 142.

The controller 120 may include a graph manager 190 which can be implemented in hardware (e.g., circuitry or one or more processors), firmware, software, or a combination thereof. The graph manager 190 can write, to an NVM (e.g., flash memory 180), data representing or corresponding to a plurality of nodes of a graph and/or perform an ANNS search on the graph stored in the NVM. Arrangements of memory controller 120 can include additional or fewer components such as those shown in FIG. 1.

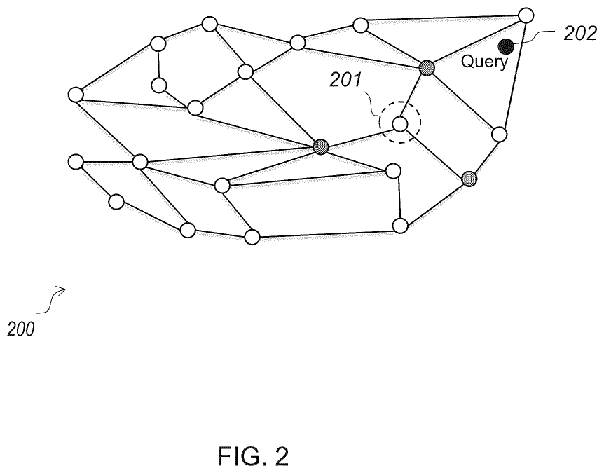

FIG. 2 illustrates an example of a graph 200 including a plurality of nodes, according to some arrangements. Graph-based ANNS algorithms (e.g., DiskANN and HNSW) can operate by iteratively traversing vectors (e.g., vectors corresponding to or related to nodes) in the graph 200 to identify nodes closest to a query 202. The term vector refers to an n-dimensional vector which has n components corresponding to respective data or values. For example, each item (e.g., data) in a data set can be represented as a corresponding vector. The term query refers to a request for data or information from a database or a data storage (e.g., DRAM, NVM, a storage in a cloud system, etc.). In some arrangements, a query (e.g., query 202) can be represented as a vector having the same dimension as vectors corresponding to or related to nodes in a graph (e.g., nodes in the graph 200).

In some arrangements, a system (e.g., flash memory system) can start a process of an ANNS algorithm from one or more entry points 201 (also referred to as entry nodes), and in each iteration, the system can employ a greedy search algorithm. In some arrangements, the system (or the ANNS algorithm) can visit a single node in each iteration, read the neighbor vectors of the currently visited node, and compute their distances to the query 202. In some arrangements, based on these distances, the system can record or identify the vectors closest to the query and select the next node to visit. In some arrangements, this iterative process can continue until no other candidate node can yield vectors closer to the query. At the end of the search, the system (or the algorithm) can provide k closest vectors to the query that have been recorded during the search. In some arrangements, the system can compress the vectors used in the search using a product quantization (PQ) compression algorithm to save on storage media and computational power. These compressed vectors are referred to as PQ vectors.

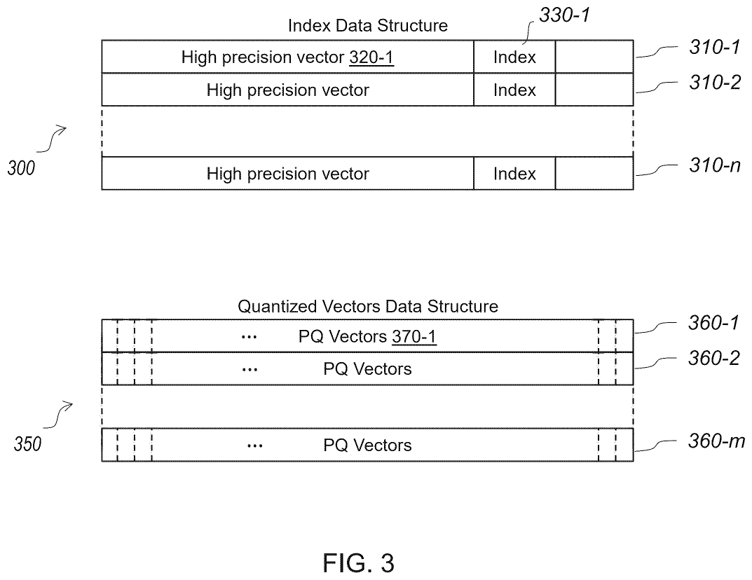

FIG. 3 illustrates an example of data structures 300, 350 in an NVM for storing data representing or corresponding to a plurality of nodes in a graph, according to some arrangements. In some arrangements, the system can store both the index and vectors in an NVM (e.g., SSD) using two distinct data structures. In some arrangements, the first data structure 300, referred to as “index data structure”, can include an entry (e.g., entry 310-1, 310-2, . . . , 310-n) for each vector in the dataset. In some arrangements, each entry (e.g., entry 310-1) can include a graph structure (e.g., Index 330-1), which lists the neighboring vectors (e.g., indexes corresponding to the neighboring vectors), and a high-precision version of the vector itself (e.g., high precision vector 320-1).

In some arrangements, the second data structure 350, referred to as “quantized vectors data structure”, can contain quantized versions of the vectors (e.g., PQ vectors 370-1). The quantized vectors data structure 350 can include a plurality of codewords (e.g., codewords 360-1, 360-2, . . . , 360-m). In some arrangements, these vectors can be compressed using PQ compression and can be packed, stored or written into SSD data units. For instance, 32 PQ vectors of the PQ vectors 370-1, each with a length of 128 bytes, can be packed into a 4KiB codeword (e.g., codeword 360-1). This arrangement can optimize storage efficiency and access speed.

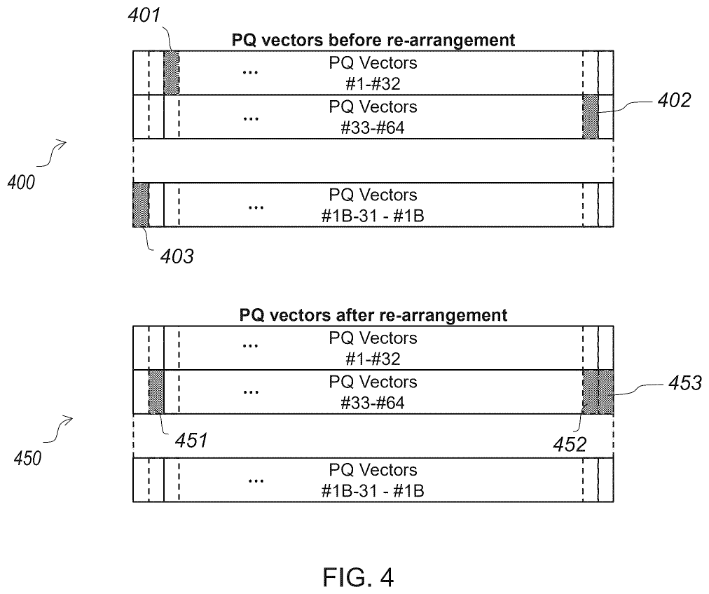

FIG. 4 illustrates an example of configurations (e.g., data structures) 400, 450 for storing data representing or corresponding to a plurality of nodes in a graph before and after rearrangement of data, according to some arrangements. The configuration 400 shows PQ vectors before rearrangement (or arrangement), while the configuration 450 shows PQ vectors after rearrangement (or arrangement). In some arrangements, the configurations 400, 450 can include a plurality of codewords, each codeword including 32 PQ vectors. The codewords may be the basic 4KiB data units of flash access and can be protected by error correction codes (ECC). In some arrangements, in each iteration of the greedy-search algorithm, the system can read a certain number of neighboring PQ vectors. In the configuration 400 before rearrangement, these vectors may be randomly stored within the structure (e.g., PQ vectors 401, 402, 403), this search process can result in multiple random read transactions. In some arrangements, the system (e.g., flash memory system, or an arrangement algorithm) can optimize the placement of vectors by arranging neighboring vectors (e.g., PQ vectors 451, 452, 453) adjacently on the NVM (e.g., SSD). This strategic arrangement can significantly reduce the number of random read transactions used to access the neighboring vectors.

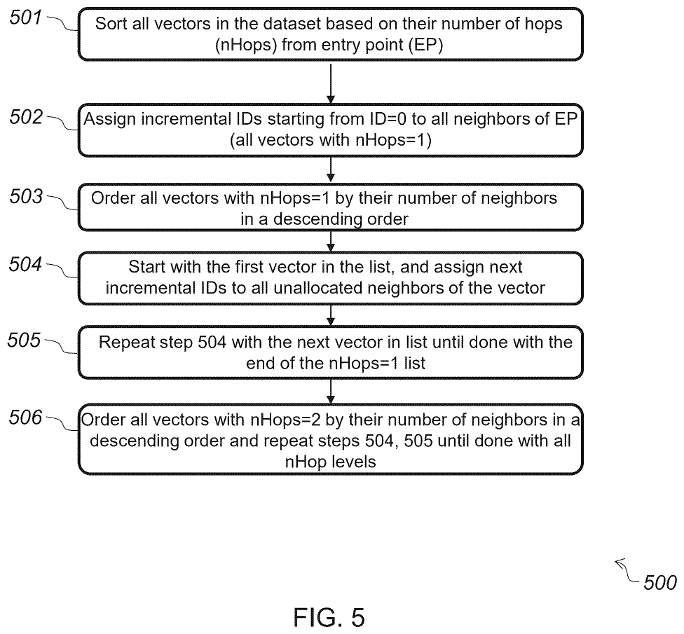

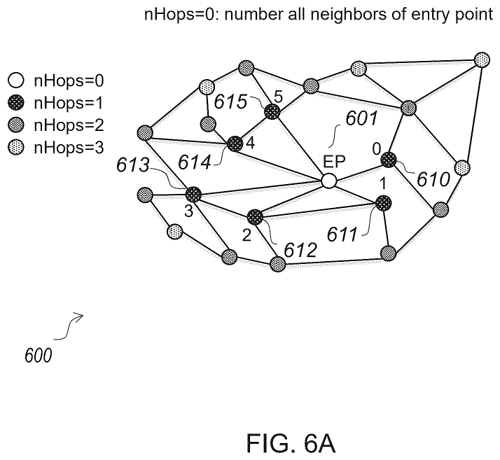

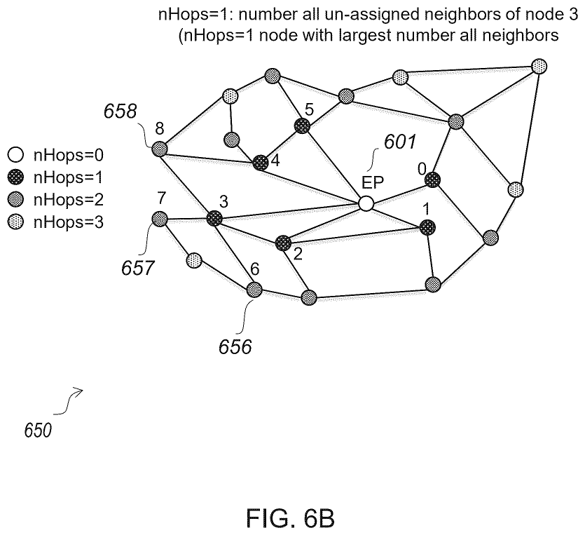

FIG. 5 is a flowchart illustrating an example methodology for arranging (or rearranging) data representing or corresponding to a plurality of nodes of a graph, according to some arrangements. FIG. 6A and FIG. 6B are diagrams 600, 650 illustrating an example of a graph including a plurality of nodes during arrangement (or rearrangement) of data representing or corresponding to the plurality of nodes, according to some arrangements.

Referring to FIG. 5, FIG. 6A and FIG. 6B, the example methodology relates to a process 500 for arranging (or rearranging) data (e.g., vectors) representing a plurality of nodes of a graph (e.g., graph shown in FIG. 6A and FIG. 6B). In some arrangements, the process 500 is performed by one or more processors (e.g. controller 120, processors 126, graph manager 190). In other arrangements, the process 500 is performed by other entities (e.g., processor 21 of computing device 20). In some arrangements, the process 500 includes more, fewer, or different steps than shown in FIG. 5.

In some arrangements, at step 501, the one or more processors can sort all vectors in the dataset based on their number of hops (nHops) from the entry point (EP) 601. At step 502, the one or more processors can assign incremental IDs, starting from ID=0, to all neighbors of the EP 601, which are the vectors with nHops=1. For example, as shown in FIG. 6A, all neighbors (neighbor vectors) 610, 611, 612, 613, 614, 615 of the EP 601 can be assigned 0, 1, 2, 3, 4, 5 as their IDs, respectively. At step 503, the one or more processors can order these vectors 610, 611, 612, 613, 614, 615 by their number of neighbors in a descending order. For example, the one or more processors can determine the number of neighbors of each of the vectors 610, 611, 612, 613, 614, 615 (which have 1 neighbor, 1 neighbor, 1 neighbor, 3 neighbors, 2 neighbors, 2 neighbors, respectively), The one or more processors can then determine an ordered list of the vectors [613, 614, 615, 610, 611, 612] in a descending order.

In some arrangements, at step 504, as shown in FIG. 6B, the one or more processors can start with the first vector in the list (e.g., vector 613) to assign the next incremental IDs (e.g., 6, 7, 8) to all unallocated neighbors (e.g., neighbor vectors 656, 657, 658 which have not been assigned IDs) of the vector. At step 505, the one or more processors can repeat step 504 with the next vector in the list (e.g., vector 614) until the end of the nHops=1 list (e.g., [613, 614, 615, 610, 611, 612]). At step 506, subsequently, the one or more processors can order all vectors with nHops=2 by their number of neighbors in a descending order, and repeat the same process (e.g., steps 504, 505) until all nHop levels (e.g., nHop=1, 2, 3) are completed.

In some arrangements, at steps 503 and 506, the ordering of the vectors within the same hop level can be random. In some arrangements, at steps 503 and 506, the ordering of the vectors within the same hop level can involve ordering the unallocated neighbors of the current vector by their distance from the vector in an ascending order and/or assigning incremental IDs accordingly. In some arrangements, the one or more processors can calculate a distance between two vectors using at least one of Euclidean distance, Manhattan distance, Minkowski distance, Cosine distance, or Hamming distance, etc.

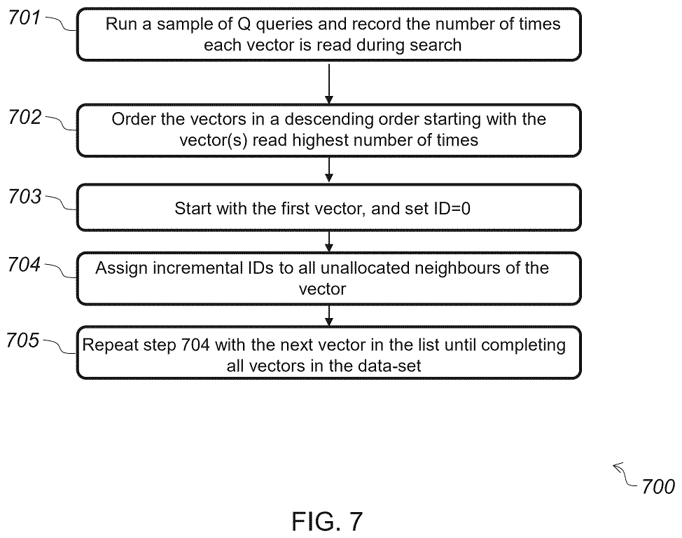

FIG. 7 is a flowchart illustrating another example methodology for arranging (or rearranging) data representing or corresponding to a plurality of nodes of a graph, according to some arrangements. In some arrangements, the example methodology relates to a process 700 for arranging (or rearranging) data (e.g., vectors) representing or corresponding to a plurality of nodes of a graph (e.g., graph 200 shown in FIG. 2). In some arrangements, the process 700 is performed by one or more processors (e.g. controller 120, processors 126, graph manager 190). In other arrangements, the process 700 is performed by other entities (e.g., processor 21 of computing device 20). In some arrangements, the process 700 includes more, fewer, or different steps than shown in FIG. 7.

In some arrangements, at step 701, the one or more processors can run, execute, make, perform, or send a sample of No queries (e.g., No representing the number of sample queries) to perform a search on a graph (e.g., graph 200). In some arrangements, the vectors corresponding to a plurality of nodes in the graph can represent a data set. The one or more processors can then record or determine the number of times each vector (e.g., a vector as a result of the search in response to a query) is read during the search. In some arrangements, at step 702, the one or more processors can order the vectors (e.g., vectors as a result of the search in response to the sample of N_{Q} queries) in a descending order, starting with the vector(s) which have been read the highest number of times. For example, the one or more processors can determine an ordered list of the vectors in a descending order, starting with the vector(s) which have been read the highest number of times.

In some arrangements, at step 703, the one or more processors can start with the first vector in the ordered list and assign an ID of 0 to the first vector (or set the first vector to the ID of 0). In some arrangements, at step 704, the one or more processors can assign incremental IDs to all unallocated (e.g., unassigned IDs) neighbors of the vector (e.g., all unallocated neighbors of a vector in the ordered list). In some arrangements, at step 705, the one or more processors can repeat this process (e.g., step 704) with the next vector in the ordered list until all vectors in the dataset have been assigned IDs. In some arrangements, the one or more processors can determine or identify vectors that have a low repetition frequency (e.g., those repeatedly read in less than 0.1% of No queries or less than any predetermined threshold). In some arrangements, for those identified vectors, the one or more processors can order the vectors by their number of hops from the entry point (nHops) in a descending order rather than ordering the vectors by the number of times each vector is read during the search.

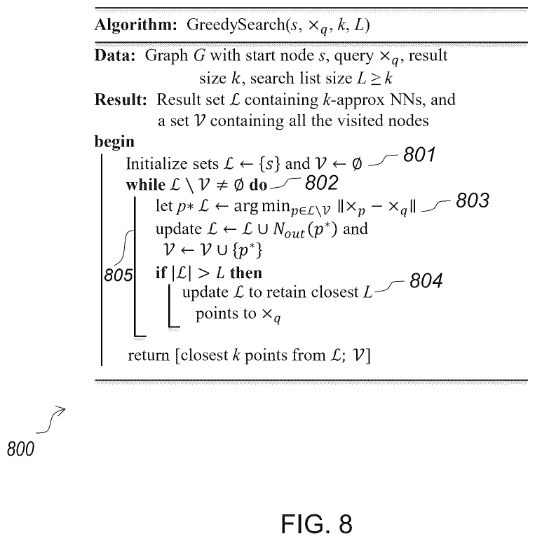

FIG. 8 illustrates an example description of a greedy search algorithm 800, according to some arrangements. In some arrangements, the greedy search algorithm 800 is performed by one or more processors (e.g. controller 120, processors 126, graph manager 190). In other arrangements, the greedy search algorithm 800 is performed by other entities (e.g., processor 21 of computing device 20). In some arrangements, the one or more processors can iteratively traverse the vectors (nodes) Xₚ in the graph G to find the nodes Xₚ closest to a query X_{q} (see line 803). In some arrangements, the one or more processors can start from one or more entry points s (see line 801) and, in each iteration 805, visits a single node, reads the neighbor-vectors of the currently visited node, and computes their distances to the query (see line 803). In some arrangements, based on these distances, the one or more processors can record or retain the vectors closest to the query (e.g., updating the result set to retain closed L vectors to X_{q}; see line 804) and choose the next node to visit. In some arrangements, the one or more processors can repeat this process until no other candidate node can yield vectors closer to the query (see line 802).

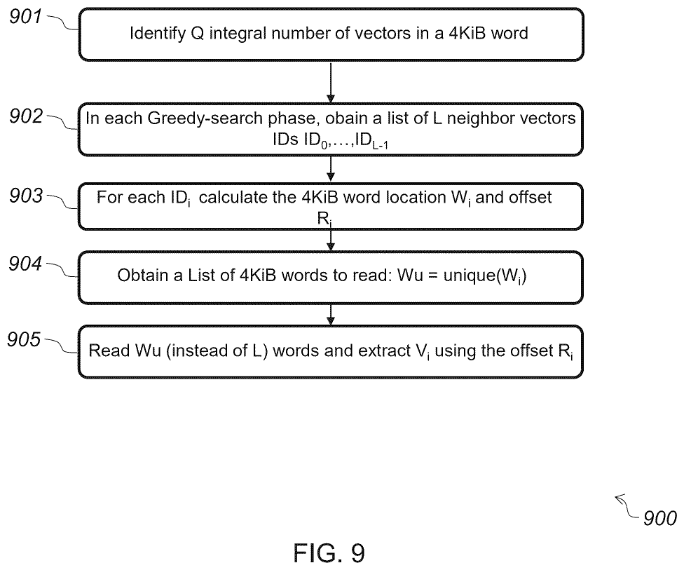

FIG. 9 is a flowchart illustrating an example methodology for reading arranged (or rearranged) data representing or corresponding to a plurality of nodes of a graph, according to some arrangements. In some arrangements, the example methodology relates to a process 900 for reading arranged (or rearranged) data (e.g., vectors) representing or corresponding to a plurality of nodes of a graph (e.g., graph 200 shown in FIG. 2), during a search process (e.g., a greedy search). In some arrangements, the process 900 is performed by one or more processors (e.g. controller 120, processors 126, graph manager 190). In other arrangements, the process 900 is performed by other entities (e.g., processor 21 of computing device 20). In some arrangements, the process 900 includes more, fewer, or different steps than shown in FIG. 9. In some arrangements, during the search process, the one or more processors can employ, execute or perform a specific scheme or process (e.g., process 900) to read arranged vectors (e.g., arranged as a result of performing the arrangement process 500 or 700).

In some arrangements, at step 901, the one or more processors can determine or identify an integral number (integer) of vectors, denoted as Q, in a word with a certain size (e.g., 4KiB word). For instance, if the PQ vector size is 128B and the word size is 4KiB, then Q equals 32. In some arrangements, at step 902, in each iteration of the Greedy-search (e.g., line 804 of each iteration 805 in FIG. 8), the one or more processors can obtain a list of IDs of L neighbor vectors (e.g., ID₀, ID₁, . . . , ID_{L-1}).

In some arrangements, at step 803, for each ID (e.g., ID₀, ID₁, . . . , ID_{L-1}), the one or more processors can calculate the location Wᵢ and offset Ri of a word (e.g., a 4KiB word) using the following equations:

$${W}_{i} = floor ( {ID}_{i} / Q ) . \qquad ( Equation 1 )$$

$${R}_{i} = ( I {D}_{i} mod Q ) * 4 K / Q . \qquad ( Equation 2 )$$

In other words, the one or more processors can determine or calculate the word location Wᵢ by taking the floor of the division of IDᵢ by Q, while the one or more processors can determine or calculate the offset Ri by multiplying the remainder of the division of IDᵢ by Q with 4K divided by Q.

In some arrangements, at step 904, the one or more processors can obtain or derive a list of 4KiB words Wᵤ to read by taking the unique values of Wᵢ using the following equation:

$${W}_{u} = unique ( {W}_{i} ) . \qquad ( Equation 3 )$$

In some arrangements, the unique function can be a deduplication operation that can eliminate duplicate copies of repeating Wᵢ. In some arrangements, the unique function can be an operation that can eliminate duplicate copies of Wᵢ which are located in the same word (e.g., the same 4KiB word).

In some arrangements, at step 905, the one or more processors can read these words (located at Wᵤ), and obtain or extract the vectors in the words using the offset Ri. In some arrangements, to further optimize performance, the one or more processors can utilize 8KiB or larger random reads.

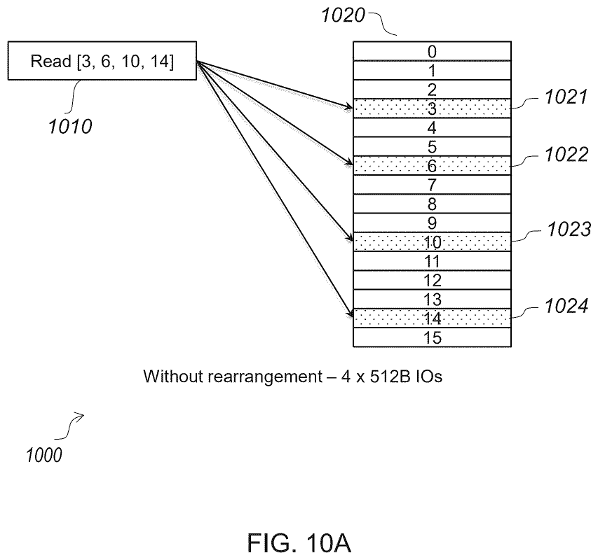

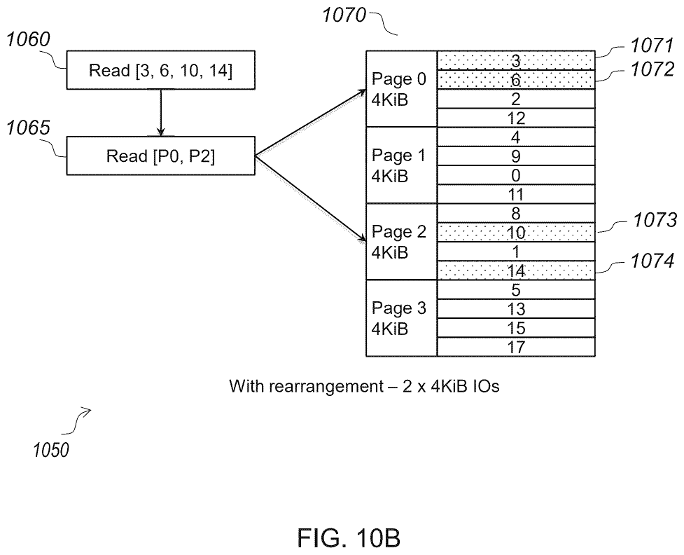

FIG. 10A and FIG. 10B are diagrams 1000 and 1050 illustrating example schemes of reading data stored in an NVM without rearrangement and with rearrangement, according to some arrangements. FIG. 10A and FIG. 10B illustrate read schemes (e.g., reading data using a list of word locations Wᵤ as shown in FIG. 9) during a search phase (e.g., iteration 805 in a greedy search). Referring to FIG. 10A, without arrangement or rearrangement of a data structure 1020 (e.g., without performing an arrangement algorithm such as those shown in FIG. 5 and FIG. 7), a system can obtain or determine a list of word locations Wᵢ=[3, 6, 10, 14] (denoted by 1010) which point to words (e.g., 4KiB words) 1021, 1022, 1023, 1024 stored in the data structure 1020. With this configuration, the system may perform a read operation multiple times (e.g., 4 times of 512B input/output operations) because the words are placed separately from each other.

In some arrangements, an arrangement algorithm (e.g., algorithms shown in FIG. 5 and FIG. 7) can apply to an index data structure by organizing the index data structure so that the indexes of neighboring vectors in the graph are placed adjacently on NVMs. This arrangement can allow for reading multiple indexes in bulk using a beamwidth, thereby enabling several indexes to be read per SSD read transaction. The term “beamwidth” refers to the number of best partial solutions that are kept as candidates at each level of a graph or a search tree, or the number of candidates that can form a limited set in which the most promising node can be expanded. For example, referring to FIG. 10B, a system (e.g., controller 120, processors 126, graph manager 190, processors 21) can perform an arrangement algorithm (e.g., algorithms shown in FIG. 5 and FIG. 7) to organize an index data structure 1070 in NVMs so that the indexes of neighboring vectors (e.g., indexes denoted by 1071, 1072, or indexes denoted by 1073, 1074) in the graph are placed adjacently on the NVMs. In some arrangements, the index data structure 1070 can be organized into multiple pages, each page having a size of 4KiB such that with an index entry size of 1KiB, each page can store up to four relevant indexes. In this configuration of index data structure 1070, the system can read multiple indexes (e.g., indexes 1071, 1072) with a single 4KiB word read. In some arrangements, the system can obtain or determine a list of index locations Wᵢ=[3, 6, 10, 14] (denoted by 1060) which point to indexes 1071, 1072, 1073, 1074 stored in the data structure 1070, obtain a list of unique index locations Wᵤ=[P0, P2] (denoted by 1067) which indicate page 0 and page 2 in the index data structure 1070. In some arrangements, the system can perform a bulk read of the page 0 to read the indexes 1071, 1072, and perform a bulk read of the page 2 to read the indexes 1073, 1074. With this configuration, the system can reduce the number of read operations (e.g., 2 times of 4KiB input/output operations) because the indexes of neighboring vectors are adjacently on the NVMs.

In some arrangements, systems and methods can employ a bulk read approach (e.g., a read scheme shown in FIG. 10B), also referred to as a beamwidth read, for both indexes and vectors. In some arrangements, this bulk read method can optimizes NVM (e.g., SSD) access by issuing bulk random reads instead of single reads, allowing for the pre-fetching of indexes to serve as future candidates along with their associated neighbor vector groups. The random reads refer to reading an individual 4KiB flash data element (in contrast “sequential read” refers to reading larger amounts of data stored contiguously in the flash). In some arrangements, the candidate list can be continuously updated during the graph search and can include the “next nodes to explore” sorted by their distances from the query. As the beamwidth increases, SSD access becomes more optimized, but the likelihood of fetching irrelevant nodes also rises.

In some arrangements, systems and methods can simultaneously fetch both indexes and vectors. The cost of a miss in prefetching may differ between indexes (e.g., the cost of a single redundant random read) and vectors (e.g., the cost of tens of redundant random reads). In some arrangements, systems and methods according to some arrangements can use different parameters for each pre-fetch and monitor the candidate list to determine when to initiate the next pre-fetch.

In some arrangements, a system (e.g. controller 120, processors 126, graph manager 190) can define two beamwidth parameters including an index beamwidth (Bᵢ) and a vector beamwidth (Bᵥ). The index beamwidth (Bᵢ) can be defined as the number of nodes for which the index is read in a single session (e.g., single SSD session). The vector beamwidth (Bᵥ) can be defined as the number of nodes for which neighboring PQ vectors are read in a single session (e.g., single SSD session).

In some arrangements, a system can further extend the beamwidth to optimize computational resources by introducing a third parameter, referred to as a “distance calculations beamwidth (B_{c})”, that controls the bulk of distance computation operations. The distance calculations beamwidth (B_{c}) can be defined as the number of candidate nodes (denoted by C) for which distances to the query of neighboring PQ vectors are calculated. In some arrangements, the relationship between these three parameters can be Bᵢ≥Bᵥ≥B_{c}. In some arrangements, the system can use the parameters to track the candidate list C and avoid distance calculations for vectors associated with nodes that are no longer relevant, even if their vectors were already pre-fetched.

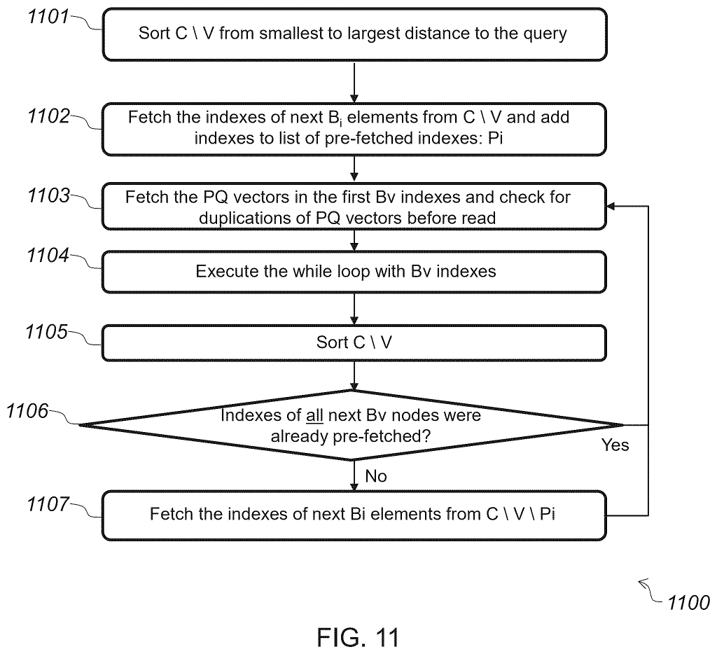

FIG. 11 is a flowchart illustrating an example methodology for performing a beam search (or a beamwidth algorithm), according to some arrangements. The example methodology relates to a process 1100 for performing a beam search (or a beamwidth algorithm). In some arrangements, the process 1100 is performed by one or more processors (e.g. controller 120, processors 126, graph manager 190). In other arrangements, the process 1100 is performed by other entities (e.g., processor 21 of computing device 20). In some arrangements, the process 1100 includes more, fewer, or different steps than shown in FIG. 11. In some arrangements, the process 1100 can begin by sorting, by the one or more processors, the candidate list, denoted as “C \ V” (e.g., set difference between a set of candidate nodes C and a set of visited nodes Vs), from the smallest distance to the largest distance to the query (step 1101).

In some arrangements, at step 1102, the one or more processors can fetch the indexes of the next Bᵢ elements from C\V and add these indexes to the list of pre-fetched indexes, Pᵢ. In some arrangements, subsequently, at step 1103, the one or more processors can fetch the PQ vectors in the first Bᵥ indexes. In some arrangements, the one or more processors can check any duplications of PQ vectors before reading the PQ vectors, and/or read unique PQ vectors only.

In some arrangements, at step 1104, the one or more processors can execute the while loop (e.g., each iteration 805 in FIG. 8) with the Bᵥ indexes. In some arrangements, at step 1105, after executing the while loop, the one or more processors can sort the candidate list, C\V (e.g., set difference between a set of candidate nodes C and a set of visited nodes Vs) again.

In some arrangements, at step 1106, the one or more processors can determine whether the indexes of all the next Bᵥ nodes have already been pre-fetched. In response to determining that the indexes of all the next Bᵥ nodes have already been pre-fetched, the one or more processors can return to step 1103 (e.g., the step of fetching the PQ vectors). Otherwise, in response to determining that the indexes of all the next Bᵥ nodes have not been pre-fetched, at step 1107, the one or more processors can fetch the indexes of the next Bᵢ elements from C\V\Pᵢ, and return to step 1103 so that the process continues accordingly.

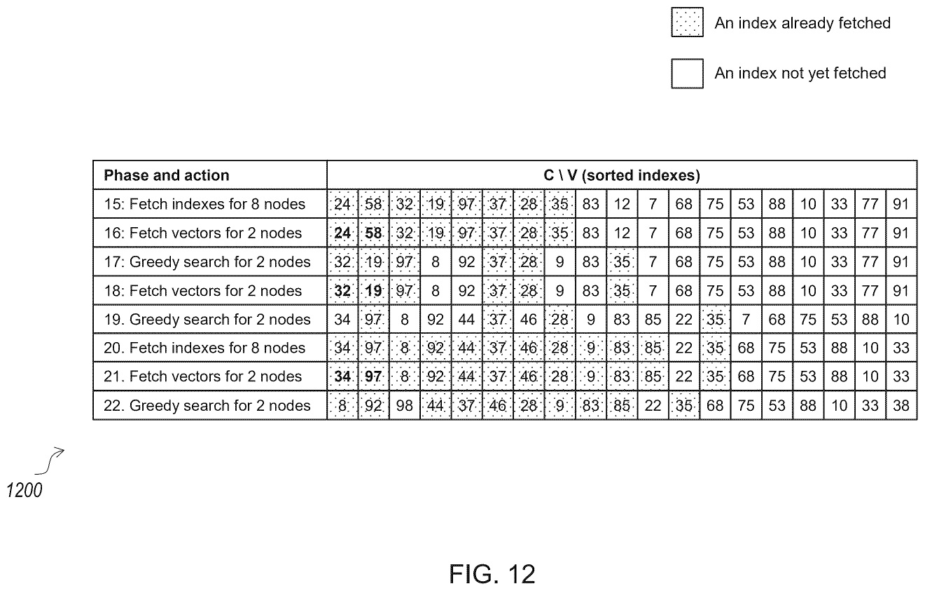

FIG. 12 is a diagram 1200 illustrating an example of sorted indexes during the execution of a beam search (or a beamwidth algorithm), according to some arrangements. The diagram 1200 shows an example of sorted indexes when Bᵢ=8 and Bᵥ=2. For example, the one or more processors can fetch the indexes of the next 8 elements from C\V and add these indexes to the list of pre-fetched indexes (see line 15 in FIG. 12 and step 1102 in FIG. 11), and fetch the PQ vectors in the first 2 indexes (e.g., indexes 24, 58; see line 16 in FIG. 12 and step 1103 in FIG. 11). Subsequently, the one or more processors can execute the while loop with the 2 indexes (see line 17 in FIG. 12 and step 1104 in FIG. 11). After executing the while loop, the one or more processors can sort the candidate list, C\V again, and determine whether the indexes of all the next 2 nodes (e.g., indexes 32, 19; see step 1106 in FIG. 11) have already been pre-fetched. In response to determining that the indexes of all the next 2 nodes (e.g., indexes 32, 19) have already been pre-fetched (see line 17), the one or more processors can fetch the next 2 nodes (see line 18 in FIG. 11) without fetching the indexes of the next 8 elements. On the other hand, in response to determining that the indexes of all the next 2 nodes (e.g., indexes 97, 34) have not been pre-fetched (see line 19), the one or more processors can fetch the indexes of the next 8 elements (see line 20 in FIG. 11 and step 1107 in FIG. 12).

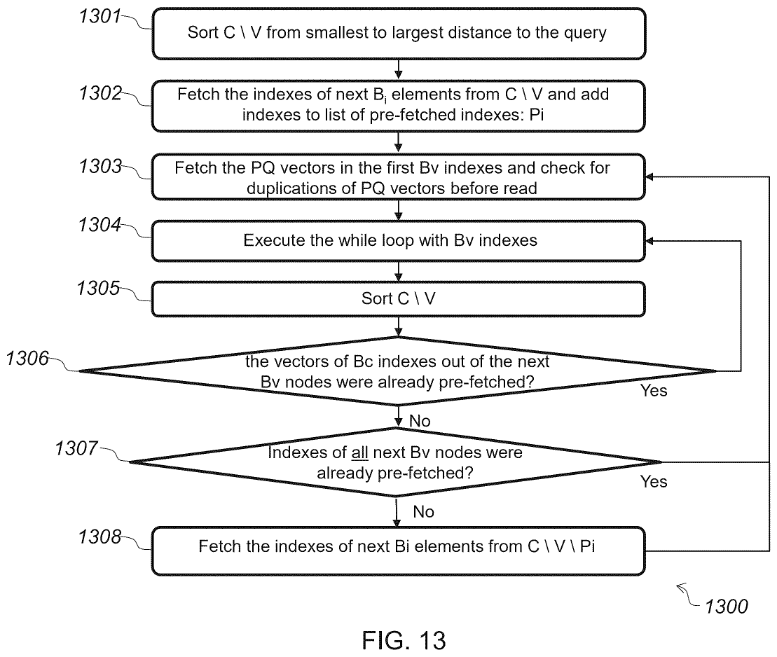

FIG. 13 is a flowchart illustrating another example methodology for performing a beam search (or a beamwidth algorithm), according to some arrangements. In some arrangements, the process 1300 is performed by one or more processors (e.g. controller 120, processors 126, graph manager 190). In other arrangements, the process 1300 is performed by other entities (e.g., processor 21 of computing device 20). In some arrangements, the process 1300 includes more, fewer, or different steps than shown in FIG. 13. In some arrangements, the one or more processors can use the parameter B_{c} to optimize compute resources. In some arrangements, the process 1300 can begin by sorting, by the one or more processors, the candidate list, denoted as C\V, from the smallest distance to the largest distance to the query (step 1301).

In some arrangements, at step 1302, the one or more processors can fetch the indexes of the next Bᵢ elements from C\V and add these indexes to the list of pre-fetched indexes, Pᵢ. In some arrangements, subsequently, at step 1303, the one or more processors can fetch the PQ vectors in the first By indexes. In some arrangements, the one or more processors can check any duplications of PQ vectors before reading the PQ vectors, and/or read unique PQ vectors only. In some arrangements, at step 1304, the one or more processors can execute the while loop (e.g., each iteration 805 in FIG. 8) with the B_{c} indexes. In some arrangements, at step 1305, after executing the while loop, the one or more processors can sort the candidate list, C\V, again.

In some arrangements, at step 1306, the one or more processors can determine whether the vectors of the B_{c} indexes out of the next Bᵥ nodes have already been pre-fetched. In response to determining that the vectors of the Be indexes out of the next Bᵥ nodes have already been pre-fetched, the one or more processors can return to step 1304 (e.g., the step of executing the while loop).

In some arrangements, at step 1307, in response to determining that the vectors of the B_{c} indexes out of the next Bᵥ nodes have not been pre-fetched, the one or more processors can determine whether the indexes of all next Bᵥ nodes have already been pre-fetched. In response to determining that the indexes of all next Bᵥ nodes have already been pre-fetched, the one or more processors can return to step 1303 (e.g., the step of fetching the PQ vectors). In some arrangements, at step 1308, in response to determining that the indexes of all next Bᵥ nodes have not been pre-fetched (e.g., neither condition in steps 1306 and 1307 is met), the one or more processors can fetch the indexes of the next Bᵢ elements from C\V\Pᵢ, and return to step 1303 so that the process continues accordingly.

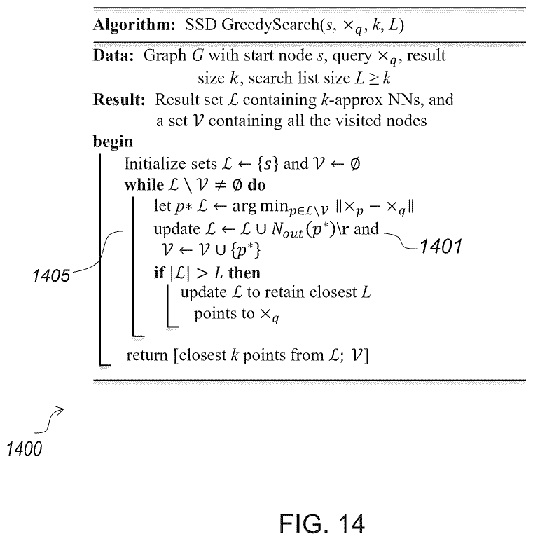

FIG. 14 is a diagram 1400 illustrating an example description of a greedy search algorithm optimized for NVM, according to some arrangements. In the context of a graph-based algorithm where vectors are stored in DRAM, such as DiskANN, the greedy search algorithm can be employed during each graph traversal iteration to read all neighbor vectors of the currently visited node. In some arrangements, a system (e.g. controller 120, processors 126, graph manager 190) can optimize or enhance the greedy search phase (e.g., each graph traversal iteration) by excluding vectors that have already been read. FIG. 14 shows this optimized or enhanced greedy search algorithm which can reduces the number of SSD reads required to access the neighbor vectors. In some arrangements, the optimized greedy search algorithm can use a list of all vectors previously read by the algorithm, which is denoted by “r” (see line 1401 in FIG. 14). In some arrangements, the system can exclude previously read vectors (see line 1401 in FIG. 14). This exclusion of previously read vectors does not impact the algorithm mathematically and can result in the same recall as the original algorithm (e.g., the algorithm shown in FIG. 8). In some arrangements, the system can perform the optimized greedy search algorithm (e.g., algorithm shown in FIG. 14) in conjunction with the vector arrangement algorithm (e.g., algorithms shown in FIG. 5 and FIG. 7). In this manner, during each graph traversal iteration (e.g., line 1405 in FIG. 14), the system can use the optimized greedy search algorithm to exclude previously visited neighbors (e.g., line 1401 in FIG. 14), while the remaining vectors are read from the arranged data structure.

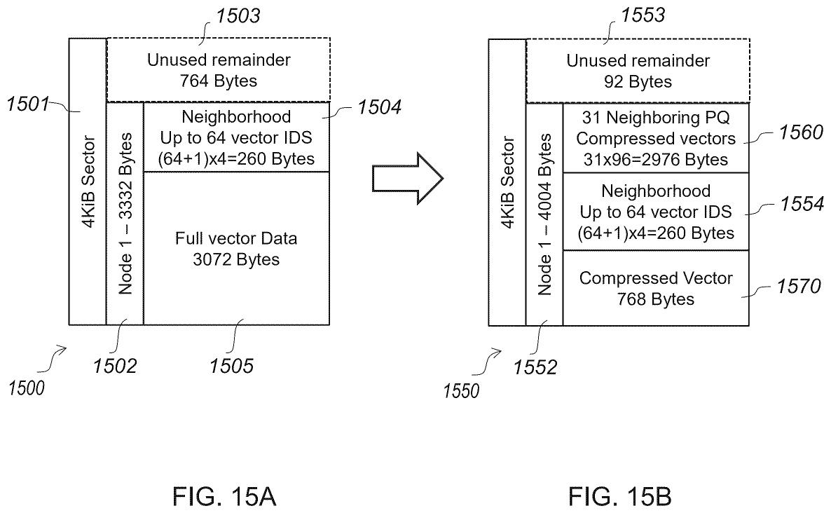

FIG. 15A and FIG. 15B illustrate an example of entries in an index data structure 1500, 1550 before and after performing an inlining scheme (e.g., vector inlining scheme), according to some arrangements. FIG. 15A shows that the index data structure 1500 may be a 4KiB sector 1501 including a node area 1502 of a particular node (e.g., a single node) and an unused area 1503. The node area 1502 may store neighbor vectors 1504 and full vector data 1505 of the particular node. Detailed information of the index data structure 1500 is shown in Table 1.

TABLE 1

| Data-set size | 10,000,000 | |
|---|---|---|
| Dimension (float) | 768 | |
| Disk PQ exists? | No | |
| Mem PQ Bytes | 96 | |
| R (max-degree) | 64 | |
| Node size | 3332 | Bytes |
| Nodes per 4KiB sector | 1 | |
| Index-file size | 38.15 | GiB |
| PQ file size | 0.89 | GiB |
| Total disk space | 39.04 | GiB |
| Wasted Index disk space | 7.12 GiB (18.7%) | |
| IOs/Node | 65 | |
| Average 4K Access/Node | 66.5 | |
| DRAM Saved | 0.89 | GiB |

As shown in FIG. 15A, the entries in the index data structure 1500 contain large unused areas (e.g., 764 Bytes). In some arrangements, a system (e.g. controller 120, processors 126, graph manager 190) can utilize the unused area to store some of the neighbor vectors inline. FIG. 15B shows that the index data structure 1550 may be a 4KiB sector 1551 including a node area 1552 of a particular node (e.g., a single node) and an unused area 1553 which is significantly smaller than the unused area 1503 in FIG. 15A. The node area 1552 may store PQ compressed neighbor vectors 1560 (also referred to as “inline vectors”), indexes of neighbor vectors 1554, and compressed vector data 1570 of the particular node. In some arrangements, during each graph traversal iteration, the system (or the greed search algorithm enhanced with inline vectors) can read the index of the currently visited node along with the inline vectors (e.g., PQ compressed neighbor vectors 1540). In some arrangements, the system can exclude the inline vectors (e.g., PQ compressed neighbor vectors 1540) from the neighbor list (e.g., indexes of neighbor vectors 1554), thereby reducing the number of SSD transactions required to read the neighbor vectors. Detailed information of the index data structure 1550 is shown in Table 2.

TABLE 2

| Data-set size | 10,000,000 | |
|---|---|---|
| Dimension (float) | 768 | |
| Disk PQ exists? | Yes | |
| Disk PQ Bytes | 768 | |
| Mem PQ Bytes | 96 | |
| R (max-degree) | 64 | |
| Max node sectors | 1 | |
| Inline PQ vectors | 31 (48%) | |
| Node size | 4004 | Bytes |
| Nodes per 4KiB sector | 1 | |
| Index-file size | 38.15 | GiB |
| PQ file size | 0.89 | GiB |
| Total disk space | 39.04 | GiB |
| Wasted Index disk space | 0.86 GiB (2.2%) | |
| IOs/Node | 34 | |
| Average 4K Access/Node | 34.8 | |
| DRAM Saved | 0.89 | GiB |

In some arrangements, the system can expand the (vector) inlining scheme by allocating an additional space, beyond the unused space, for inline vectors. In some arrangements, the amount of inline vector space can serve as a parameter that finely controls the performance versus the cost of the ANNS algorithm. In some arrangements, the system can increase the number of inline vectors to reduce the number of SSD read transactions required for neighbor vectors, while simultaneously increasing the footprint of the index data structure.

In some arrangements, the system can align the number of inline vectors with segments in a SSD file read command. In some arrangements, the system can have the number of inline vectors remain unaligned. For instance, assuming 512B segments, each entry can have inline vectors such that the entry size is 2KiB aligned. The entry may be a data structure used by each node (e.g., the structure of an entry is shown in FIG. 15A and FIG. 15G, the structure 300 of index entries is shown in FIG. 3). In some arrangements, vector inlining can be compatible with index data structures that include both full-precision vectors and compressed full-precision vectors. For example, if the full-precision vector is quantized to a 768B vector, each entry can have 3068B (4096−768−65×4=3068) of unused space, allowing the unused area to fit up to 23 PQ vectors of size 128B inline. In some arrangements, the system can reduce the average number of index and vector reads by utilizing at least one of an arrangement algorithm (e.g., algorithms shown in FIG. 5 and FIG. 7), greedy search optimization (e.g., algorithms shown in FIG. 11, FIG. 13 and FIG. 14), or inline vectors (e.g., scheme shown in FIG. 15), thereby contributing to a significant reduction in the host's CPU load and power consumption.

In some arrangements, systems and methods can include an optional static cache of vectors that can be stored in DRAM. In some arrangements, during each graph traversal iteration of a greedy search, a system (e.g. controller 120, processors 126, graph manager 190) can check or determine which of the neighbors reside in the cache and fetch neighbors residing or stored in the cache, while the remaining neighbors are read from the SSD. In some arrangements, the system can use a parameter to control the size of the static cache, enabling a trade-off between search performance and search media cost.

In some arrangements, the system can arrange vectors according to their number of hops from the entry point in an ascending order and populate a fixed-size static cache based on their position in the list. Here, populating a cache refers to preloading or storing frequently accessed data into a cache to improve the efficiency and speed of the search process. For example, vectors having a lower number of hops can be preloaded or stored into the fixed-size static cache more than vectors having a higher number of hops. In some arrangements, the system can run or execute a sample of Q queries, and record or determine the number of times each vector is read during the search. In some arrangements, the system can order the vectors in a descending order, starting with the vector(s) read the highest number of times, and populate a fixed-size static cache based on their position in the list. For example, vectors read a higher number of times can be preloaded or stored into the fixed-size static cache more than vectors read a lower number of times.

Some arrangements in the present disclosure has undergone laboratory testing, and the main results are outlined below. Table 3 below shows the average number of read transactions (Mean I/O) required to read the neighbor PQ vectors when using some arrangements in the present disclosure to search different vector datasets. The results shown in Table 3 are based on searches conducted on common industry datasets, including Falcon with 240 million vectors (referred to as “Falcon240M”), Falcon with 50 million vectors (referred to as “Falcon50M”), and WikiAll with 50 million vectors (referred to as “WikiAll50M”). The findings indicate that the greedy search optimization reduces the Mean I/O by 24% to 31%. When combined with the arrangement algorithm (e.g., algorithms shown in FIGS. 5 and 7), the reduction in Mean I/O reaches 35% to 39%.

TABLE 3

| | Falcon240M, | Falcon50M, | WikiAll50M, |
|---|---|---|---|
| | Lsearch = 80 | Lsearch = 40 | Lsearch = 40 |
| | Mean IO | Mean IO | Mean IO |
| Baseline | 5923.3 | 3192.7 | 3171.5 |
| Greedy search | 4067.4 (−31.3%) | 2431.6 (−23.8%) | 2329.5 (−26.5%) |
| optimization | | | |
| Greedy search | 3602.2 (−39.2%) | 2075.2 (−35.0%) | 1936.7 (−38.9%) |
| optimization + | | | |
| Vector | | | |
| arrangement | | | |
| by nHop | | | |

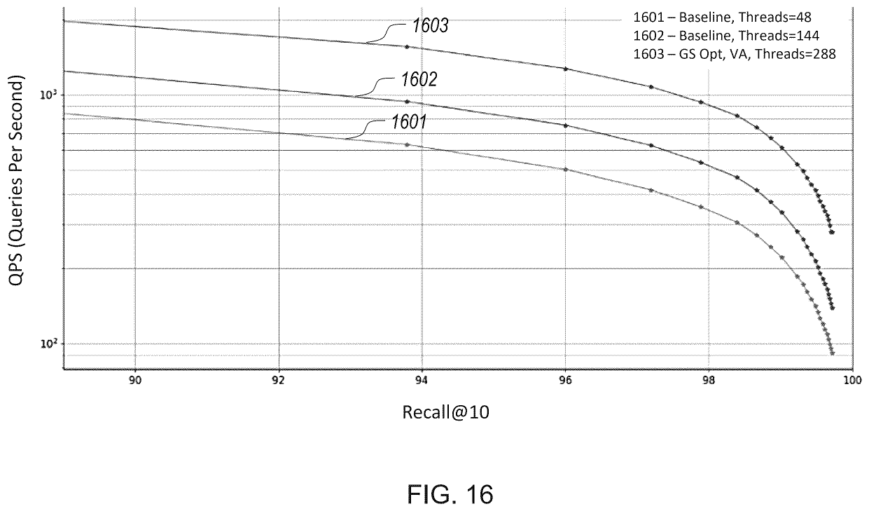

FIG. 16 is a diagram illustrating example results (queries per second (QPS) vs. Recall@10) of throughput of a beam search, according to some arrangements. The X-axis represents Recall@10, while the Y-axis represents throughput measured in queries per second (QPS). Here, Recall@10 refers to a performance metric used in a search system to measure the proportion of the 10 closest vectors to the query vector within the top 10 results returned by the search system. In other words, Recall@10 can indicate how many of the relevant documents or data are found among the first 10 results. The reduction in Mean I/O translates to higher search throughput. As illustrated in FIG. 16, a first baseline implementation achieves a throughput of 843 QPS at 95% recall@10, represented by the curve 1601. As represented by the curve 1601, A second baseline implementation with less threads (48 threads) than the first implementation (144 threads) achieves a throughput less than the throughput of the first baseline implementation. By employing greedy-search optimization (e.g., algorithms shown in FIGS. 11 and 13) and vector arrangement (e.g., algorithms shown in FIGS. 5 and 7), a third implementation of the greedy search algorithm according to some arrangements with 288 threads can achieve a throughput of 1,410 QPS, represented by the curve 1603, which signifies a 67% increase in performance. The testing used a Dell server 161 with 48 cores, WikiAll50M dataset, RID 0 (4× SSDs) with parameters of no fixed size cache, Bᵢ=1, Bᵥ=1, inline=0, number of PQ compressed vectors=128, DiskPQ=0, R=64, Lbuild=200, and threads ranging from 48 to 432, and search list size L ranging from 10, 20, and up to 250. DiskPQ is the number of PQ bytes used for quantizing the full precision vector stored in the index. “DiskPQ=0” means no quantization is used, and the full precision vector is used in the index. R is the maximal number of nodes that can be connected to each node. Lbuild is a parameter controlling the quantality of the index build. The largest the parameter the built index is “better” but build time is increased.

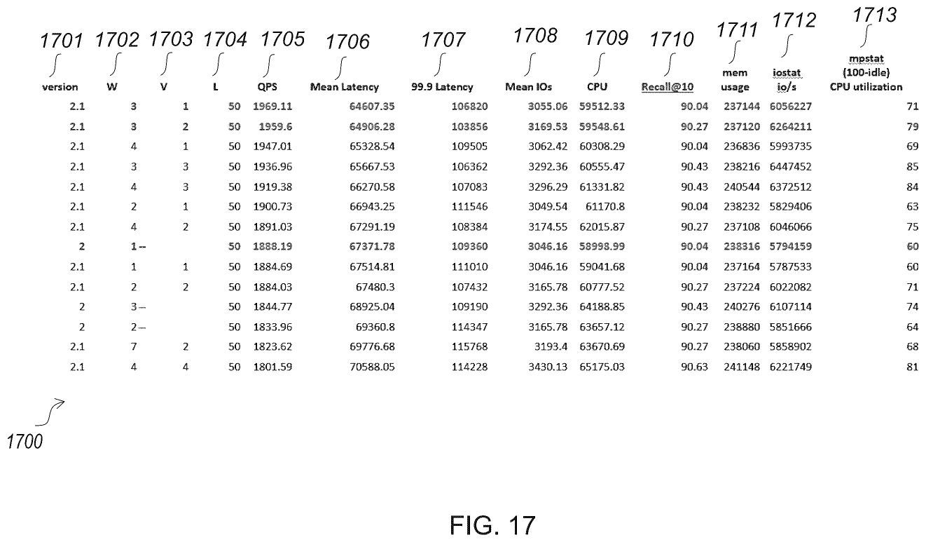

FIG. 17 is a table 1700 showing example results of performance of a beam search, according to some arrangements. The table 1700 includes columns of version 1701, W 1702 (index beamwidth Bᵢ), V 1703 (vector beamwidth Bᵥ), search list size L 1704, QPS 1705, mean latency 1706, 99.9-percentile latency 1707, Mean I/O 1708, CPU performance 1709 (e.g., some measure of the CPU load), Recall@10 1710, memory usage 1711, IO/s 1712, CPU utilization 1713 (e.g., the percentage of time the CPU is busy). The effect of independent index and vector beamwidths was measured by quantifying the throughput for different values of index beamwidth (W) and vector beamwidth (V). The table 1700 demonstrates that the optimal value was achieved with W=3 and V=1 or 2. This configuration resulted in a throughput that is 5% higher compared to the baseline implementation with W=1 and V=1.

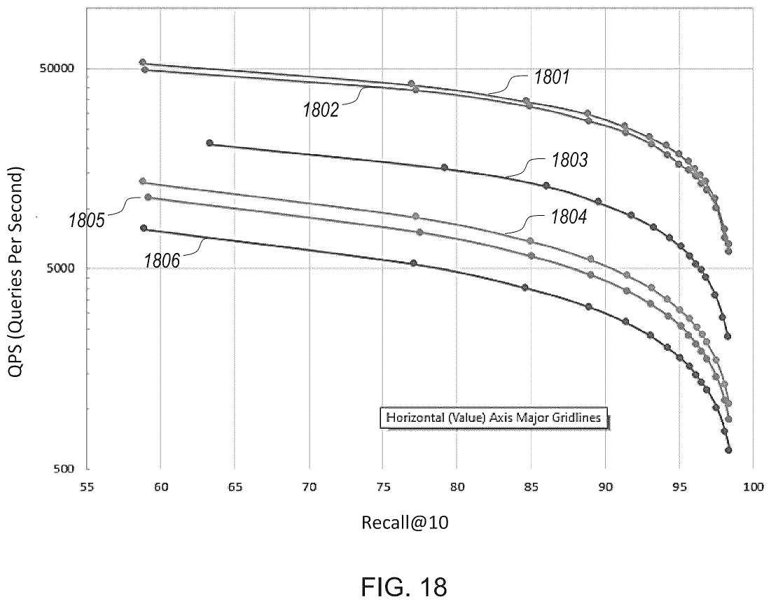

FIG. 18 is a diagram illustrating example results (QPS vs. Recall@10) of throughput of a beam search, according to some arrangements. FIG. 18 shows the effect of vector inlining by measuring the throughput for different numbers of inline vectors. As shown in FIG. 18, the curves 1801, 1802, 1803, 1804, 1805, 1806 correspond to the tested configurations of (1) aligned (all inline) with 6 drives (e.g., 6 disk drives), W=3, V=1; (2) unaligned (all inline) with 6 drives W=3, V=1; (3) unaligned (57 inline) with 6 drives W=3, V=3; (4) unaligned (48 inline) with 6 drives, W=3, V=1; (5) unaligned (44 inline) with 6 drives, W=3, V=1; and (6) unaligned (32 inline) with 6 drives, W=4, V=1. As shown in FIG. 18, the results indicate that throughput increases as the number of inline vectors increases, although this comes with the increased cost of a larger SSD footprint. FIG. 18 also illustrates the impact of different selections of the number of inline vectors, selections of whether the resulting index entry is aligned or not aligned, to the segment size of the file read transaction.

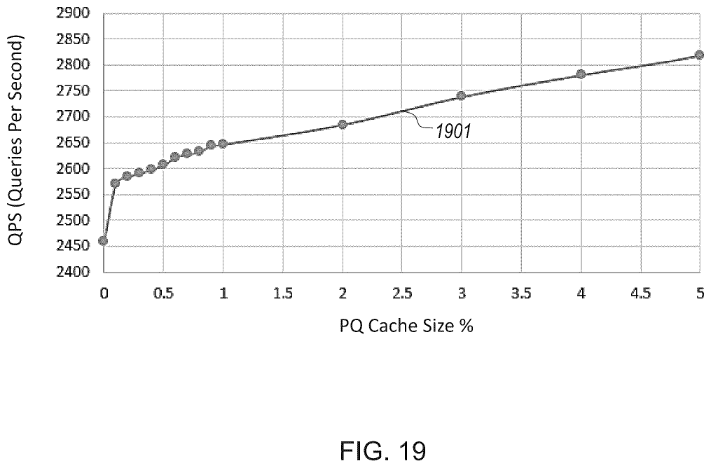

FIG. 19 is a diagram illustrating example results (QPS vs. PQ cache size) of throughput of a vector selection algorithm using a product compression (PQ) cache scheme, according to some arrangements. The effect of the static cache was evaluated by adjusting the cache size and measuring the throughput. FIG. 19 demonstrates that a cache size of 1% of the PQ vectors increases the throughput from 2450 QPS (without PQ cache) to 2650 QPS, representing an approximate 8% increase, represented by the curve 1901. The configurations tested include unaligned (32 inline) with 6 drives, W=4, and V=1.

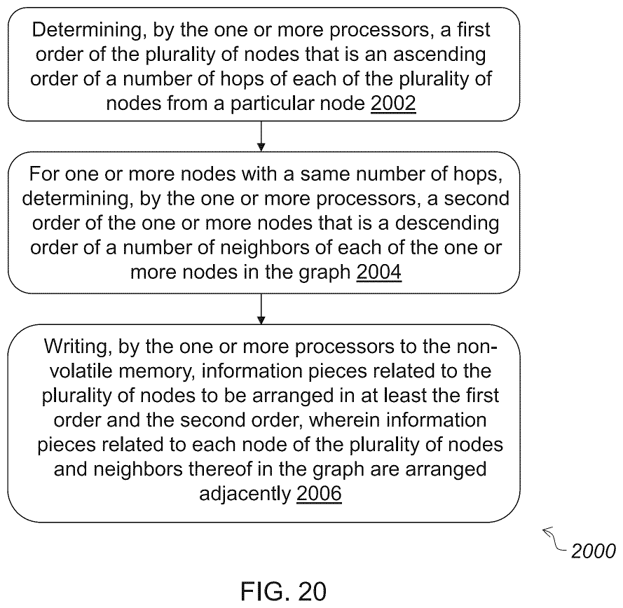

FIG. 20 is a flowchart illustrating an example methodology for writing, to an NVM, data representing a plurality of nodes of a graph, according to some arrangements. In some arrangements, the example methodology relates to a process 2000 for writing, to a non-volatile memory (e.g., flash memory 180), data representing a plurality of nodes of a graph (e.g., graph 200, 500, 550). In some arrangements, the process 2000 is performed by one or more processors (e.g. controller 120, processor 126, graph manager 190). In other arrangements, the process 2000 is performed by other entities (e.g., processor 21 of computing device 20). In some arrangements, the process 1500 includes more, fewer, or different steps than shown in FIG. 20.

In this example, the process 2000 begins in step S2002 by determining, by one or more processors (e.g., controller 120, processor 126, graph manager 190, processor 21), a first order of the plurality of nodes that is an ascending order of a number of hops of each of the plurality of nodes from a particular node (e.g., arranging vectors in the ascending order of the number of hops; see FIG. 5).

In step S2004, in some arrangements, for one or more nodes with a same number of hops, the one or more processors may determine a second order of the one or more nodes that is a descending order of a number of neighbors of each of the one or more nodes in the graph (e.g., arranging vectors at the same number of hops in the descending order of the number neighbors thereof; see steps 503 to 505 in FIG. 5).

In step S2006, in some arrangements, the one or more processors may write, to the non-volatile memory, information pieces related to the plurality of nodes to be arranged in at least the first order and the second order. In some arrangements, information pieces related to each node of the plurality of nodes and neighbors thereof in the graph may be arranged adjacently. For example, as shown in FIG. 4, as a result of writing or arranging the information pieces according to the first order and the second order, neighboring vectors (e.g., PQ vectors 451, 452, 453) can be arranged adjacently on the NVM (e.g., SSD).

In some arrangements, the particular node may be an entry point of the graph (e.g., EP 601 in FIG. 6A and FIG. 6B). In some arrangements, the one or more processors may repeat determining of the second order for each number of hops starting from 1 and incrementing to a maximum number of hops of the plurality of nodes (e.g., step 506 in FIG. 5).

In some arrangements, each of the information pieces related to the plurality of nodes may include a vector. The one or more processors may assign one or more integers in a range from an initial integer to a first integer, to one or more nodes with one hop (e.g., IDs 0, 1, 2, 3, 4, 5 in FIG. 6A). The one or more processors may determine a first descending order of the one or more nodes with one hop that is a descending order of a number of neighbors of each of the one or more nodes with one hop (e.g., an ordered list of the vectors [613, 614, 615, 610, 611, 612] in a descending order in FIG. 6A). For a first node (e.g., node 613) having a largest number of neighbors among the one or more nodes with one hop, the one or more processors may assign one or more integers in a range from a second integer larger than the first integer to a third integer, to one or more neighbors of the first node (e.g., IDs 6, 7, 8 in FIG. 6B). For a second node next to the first node in the first descending order, the one or more processors may assign one or more integers in a range from a fourth integer larger than the third integer to a fifth integer, to one or more neighbors of the second node. The one or more processors may write, to the non-volatile memory, a plurality of vectors related to nodes corresponding to integers in a range from the initial integer to the fifth integer, to be adjacent to each other and arranged in an increasing order from the initial integer to the fifth integer (e.g., IDs from 0, 1, 2, . . . , 6, 7, 8, . . . as shown in FIGS. 6A and 6B).

In some arrangements, in assigning the one or more integers in the range from the second integer to the third integer, to the one or more neighbors of the first node, the one or more processors may calculate a distance of a vector related to each of the one or more neighbors of the first node, from a vector related to the first node. The one or more processors may assign the one or more integers in the range from the second integer to the third integer, to the one or more neighbors of the first node in an increasing order of the distance of the vector related to each of the one or more neighbors of the first node. For example, in some arrangements, at steps 503 and 506 in FIG. 5, the ordering of the vectors within the same hop level can involve ordering the unallocated neighbors of the current vector by their distance from the vector (the vector of the first node) in an ascending order and/or assigning incremental IDs accordingly.

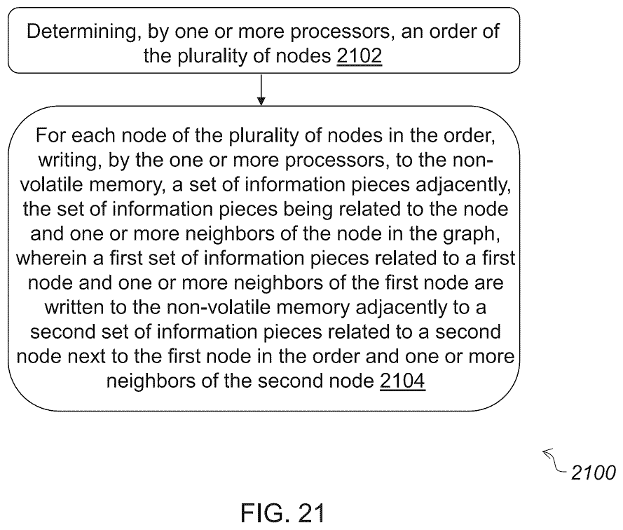

FIG. 21 is a flowchart illustrating another example methodology for writing, to an NVM, data representing a plurality of nodes of a graph, according to some arrangements. In some arrangements, the example methodology relates to a process 2100 for writing, to a non-volatile memory (e.g., flash memory 180), data representing a plurality of nodes of a graph (e.g., graph 200, 500, 550). In some arrangements, the process 2100 is performed by one or more processors (e.g. controller 120, processor 126, graph manager 190). In other arrangements, the process 2100 is performed by other entities (e.g., processor 21 of computing device 20). In some arrangements, the process 2100 includes more, fewer, or different steps than shown in FIG. 21.

In this example, the process 2100 begins in step S2102 by determining, by one or more processors (e.g., processor 126, graph manager 190, processor 21), an order of the plurality of nodes (e.g., an ascending order of the number of hops of the nodes, or a descending order of the number of neighbor nodes of a particular node).

In step S2104, in some arrangements, for each node of the plurality of nodes in the order, the one or more processors may write, to the non-volatile memory, a set of information pieces adjacently, the set of information pieces (e.g., vectors) being related to the node and one or more neighbors of the node in the graph. In some arrangements, a first set of information pieces related to a first node and one or more neighbors of the first node may be written to the non-volatile memory adjacently to a second set of information pieces related to a second node next to the first node in the order and one or more neighbors of the second node. For example, as shown in FIG. 4, as a result of writing or arranging the information pieces according to a certain order (e.g., an ascending order of the number of hops of the nodes, and/or a descending order of the number of neighbor nodes of a particular node), neighboring vectors of the first node and neighboring vectors of the second node (e.g., PQ vectors 451, 452, 453) can be arranged adjacently on the NVM (e.g., SSD).

In some arrangements, the order of the plurality of nodes may include an ascending order of a number of hops of each of the plurality of nodes from a particular node that is an entry point of the graph (e.g., step 506 in FIG. 5). In some arrangements, the order of the plurality of nodes may further include a descending order of a number of neighbors of each of one or more nodes at a same number of hops in the graph (e.g., steps 503 to 505). In some arrangements, the order of the plurality of nodes may further include a random order of one or more nodes at a same number of hops in the graph.

In some arrangements, each of the information pieces related to the plurality of nodes may include a vector. In some arrangements, the one or more processors may execute a plurality of queries on the graph to perform search for sample vectors (e.g., step 701 in FIG. 7). In response to executing the plurality of queries, the one or more processors may determine the order of the plurality of nodes to be a descending order of a number of times for each of vectors related to the plurality of nodes to be read during the search (e.g., step 702). The one or more processors may determine that a number of times for each of one or more vectors to be read, among the vectors related to the plurality of nodes, is less than a threshold. The one or more processors may determine the order of the one or more vectors to be an order of a number of hops of each of nodes corresponding the one or more vectors from a particular node that is an entry point of the graph. For example, the one or more processors can determine or identify vectors that have a low repetition frequency (e.g., those repeatedly read in less than 0.1% of No queries or less than any predetermined threshold). For those identified vectors, the one or more processors can order the vectors by their number of hops from the entry point (nHops) in a descending order rather than ordering the vectors by the number of times each vector is read during the search.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

1. A method for writing, to a non-volatile memory, data representing a plurality of nodes of a graph, wherein the graph represents arrangement of data in a dataset, the method comprising:
determining, by one or more processors, a first order of the plurality of nodes that is an ascending order of a number of hops of each of the plurality of nodes of the graph from a particular node;
for one or more nodes with a same number of hops, determining, by the one or more processors, a second order of the one or more nodes that is a descending order of a number of neighbors of each of the one or more nodes in the graph;
writing, by the one or more processors to the non-volatile memory, information pieces related to the plurality of nodes to be arranged in at least the first order and the second order, wherein information pieces related to each node of the plurality of nodes and neighbors thereof in the graph are arranged adjacently; and
performing a nearest neighbor search on the dataset by retrieving the information pieces from the non-volatile memory, wherein the arrangement of information pieces is configured to optimize performance of the nearest neighbor search.

2. The method of claim 1, wherein the particular node is an entry point of the graph.

3. The method of claim 1, wherein determining the second order is repeated for each number of hops starting from 1 and incrementing to a maximum number of hops of the plurality of nodes.

4. The method of claim 1, wherein each of the information pieces related to the plurality of nodes includes a vector.

5. The method of claim 4, further comprising:
assigning one or more integers in a range from an initial integer to a first integer, to one or more nodes with one hop;
determining a first descending order of the one or more nodes with one hop that is a descending order of a number of neighbors of each of the one or more nodes with one hop;
for a first node having a largest number of neighbors among the one or more nodes with one hop, assigning one or more integers in a range from a second integer larger than the first integer to a third integer, to one or more neighbors of the first node;
for a second node next to the first node in the first descending order, assigning one or more integers in a range from a fourth integer larger than the third integer to a fifth integer, to one or more neighbors of the second node; and
writing, to the non-volatile memory, a plurality of vectors related to nodes corresponding to integers in a range from the initial integer to the fifth integer, to be adjacent to each other and arranged in an increasing order from the initial integer to the fifth integer.

6. The method of claim 5, wherein assigning the one or more integers in the range from the second integer to the third integer, to the one or more neighbors of the first node comprises:
calculating a distance of a vector related to each of the one or more neighbors of the first node, from a vector related to the first node; and
assigning the one or more integers in the range from the second integer to the third integer, to the one or more neighbors of the first node in an increasing order of the distance of the vector related to each of the one or more neighbors of the first node.

7. A method for writing, to a non-volatile memory, data representing a plurality of nodes of a graph, wherein the graph represents arrangement of data in a dataset, the method comprising:
determining, by one or more processors, an order of the plurality of nodes;
for each node of the plurality of nodes in the order, writing, by the one or more processors, to the non-volatile memory, a set of information pieces adjacently, the set of information pieces being related to the node and one or more neighbors of the node in the graph,
wherein a first set of information pieces related to a first node and one or more neighbors of the first node are written to the non-volatile memory adjacently to a second set of information pieces related to a second node next to the first node in the order and one or more neighbors of the second node; and
performing a nearest neighbor search on the dataset by retrieving the information pieces from the non-volatile memory, wherein the arrangement of information pieces is configured to optimize performance of the nearest neighbor search.

8. The method of claim 7, wherein the order of the plurality of nodes includes an ascending order of a number of hops of each of the plurality of nodes from a particular node that is an entry point of the graph.

9. The method of claim 8, wherein the order of the plurality of nodes further includes a descending order of a number of neighbors of each of one or more nodes at a same number of hops in the graph.

10. The method of claim 8, wherein the order of the plurality of nodes further includes a random order of one or more nodes at a same number of hops in the graph.

11. The method of claim 7, wherein each of the information pieces related to the plurality of nodes includes a vector.

12. The method of claim 11, further comprising:
executing a plurality of queries on the graph to perform search for sample vectors; and
in response to executing the plurality of queries, determining the order of the plurality of nodes to be a descending order of a number of times for each of vectors related to the plurality of nodes to be read during the search.

13. The method of claim 12, further comprising:
determining that a number of times for each of one or more vectors to be read, among the vectors related to the plurality of nodes, is less than a threshold; and
determining the order of the one or more vectors to be an order of a number of hops of each of nodes corresponding the one or more vectors from a particular node that is an entry point of the graph.

14. A flash memory system comprising:
a non-volatile memory configured to store information pieces related to a plurality of nodes of a graph, wherein the graph represents arrangement of data in a dataset; and
one or more processors configured to:
determine an order of the plurality of nodes; and
for each node of the plurality of nodes in the order, writing to the non-volatile memory, a set of information pieces adjacently, the set of information pieces being related to the node and one or more neighbors of the node in the graph,
wherein a first set of information pieces related to a first node and one or more neighbors of the first node are written to the non-volatile memory adjacently to a second set of information pieces related to a second node next to the first node in the order and one or more neighbors of the second node; and
perform a nearest neighbor search on the dataset by retrieving the information pieces from the non-volatile memory, wherein the arrangement of information pieces is configured to optimize performance of the nearest neighbor search.

15. The flash memory system of claim 14, wherein the order of the plurality of nodes includes an ascending order of a number of hops of each of the plurality of nodes from a particular node that is an entry point of the graph.

16. The flash memory system of claim 15, wherein the order of the plurality of nodes further includes a descending order of a number of neighbors of each of one or more nodes at a same number of hops in the graph.

17. The flash memory system of claim 15, wherein the order of the plurality of nodes further includes a random order of one or more nodes at a same number of hops in the graph.

18. The flash memory system of claim 14, wherein each of the information pieces related to the plurality of nodes includes a vector.

19. The flash memory system of claim 18, wherein the one or more processors are configured to:
execute a plurality of queries on the graph to perform search for sample vectors; and
in response to executing the plurality of queries, determine the order of the plurality of nodes to be a descending order of a number of times for each of vectors related to the plurality of nodes to be read during the search.

20. The flash memory system of claim 19, wherein the one or more processors are further configured to:
determine that a number of times for each of one or more vectors to be read, among the vectors related to the plurality of nodes, is less than a threshold; and
determine the order of the one or more vectors to be an order of a number of hops of each of nodes corresponding the one or more vectors from a particular node that is an entry point of the graph.
